(19) United States
(12) Patent Application Publication
(10) Pub. No.: US 2018/0061144 A1
(43) Pub. Date: Mar. 1, 2018

(54) Electronic Self-Service Parking Payment System

(71) Applicants: Yuqiao Huang, Champaign, IL (US); Heyuan Qiao, Champaign, IL (US)

(72) Inventors: Yuqiao Huang, Champaign, IL (US); Heyuan Qiao, Champaign, IL (US)

(21) Appl. No.: 15/245,477

(22) Filed: Aug. 24, 2016

(51) Int. Cl. G07B 15/02; H04W 4/00; G06Q 20/32

(52) U.S. Cl. CPC G07B 15/02; H04W 4/008; H04L 67/42; G06Q 20/3276; G06Q 20/3278; G06Q 20/3274

(57) ABSTRACT

This invention is a system and method for allowing a user to efficiently pay for vehicle parking without using cash or a physical charge card, without interacting with a human attendant, and without utilizing equipment beyond a typical mobile device and an inexpensive machine installed in the parking space.

A user locates an empty parking space and interfaces his mobile device with the parking machine. The parking machine starts a timer. When the user is ready to leave, he indicates so on his mobile device. The parking machine stops the timer. The charge is computed based on actual usage time. The payment is made via the user's mobile device.

### BACKGROUND

Parking a vehicle and paying for the parking, particularly in a major city, is often difficult and time-consuming. Many existing parking systems require cash or card payments, which slows down the process. Existing parking systems also typically require vehicle operators to pay in advance for a pre-specified amount of time, which may be inefficient if a vehicle operator does not know how long he will need to park his vehicle. Some existing parking systems also require human attendants during all hours of operations, while other parking systems operate on an “honor system,” where there is no mechanism to enforce payments from vehicle operators. While there are now some automated parking systems, one or more of the above issues is generally still present and such systems, and such systems require expensive equipment or equipment that must be installed in any vehicle that is going to use such systems. It would be useful to have a new and innovative automated parking system that is inexpensive and does not require additional equipment beyond what a typical vehicle operator already owns and carries, and that solves the current problems with existing parking systems.

### SUMMARY

This invention relates to an automated system and method for allowing users to park their vehicle and pay for exactly the time that was used. The system is inexpensive to install and maintain, and the only equipment required of a user is a mobile computing device which the vast majority of users already owns and carries everywhere.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is an overview of the composition of an embodiment of the system or method.

FIG. 2 is a flow chart describing the overall flow of an embodiment of the system or method.

FIG. 3 is a flow chart describing the client mobile device of an embodiment of the system or method.

### DETAILED DESCRIPTION

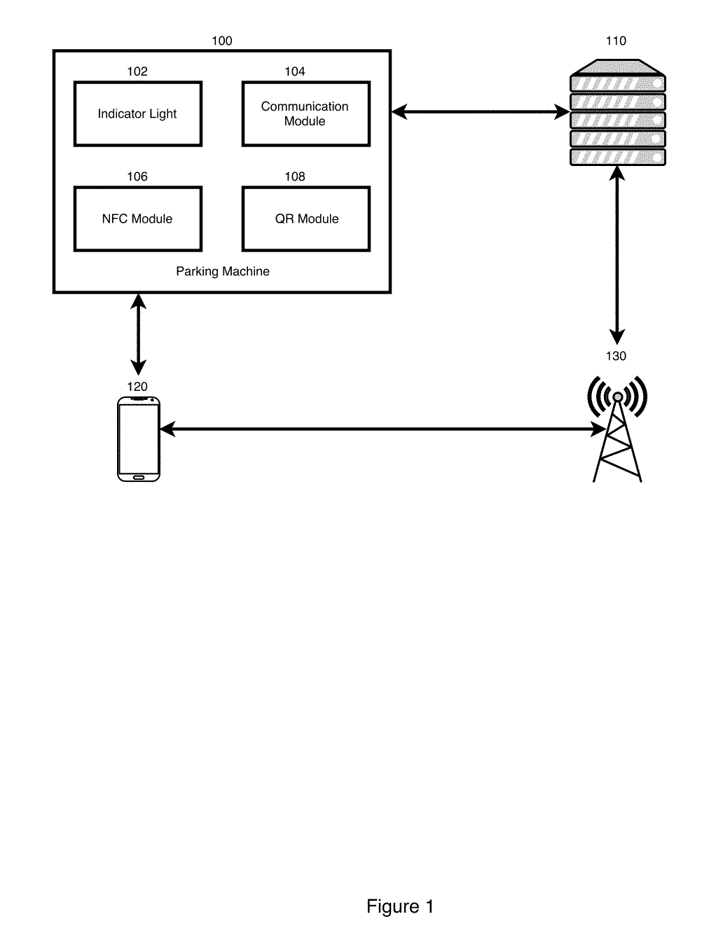

In the particular embodiment illustrated in FIG. 1, the system is composed of a parking machine 100, server 110, mobile device 120, and mobile device communication means 130. Parking machine 100 is composed of indicator light 102, communication module 104, QR module 108, and optionally NFC module 106.

Indicator light 102 is a light that capable of illuminating in at least three different colors, and is visible from the exterior of parking machine 100. Indicator light 102 may be composed of a single or multiple light bulbs, and is typically a light-emitting diode (LED).

Communication module 104 is composed of hardware and software that is capable of transmitting and receiving electromagnetic signals of the type that are commonly used in computer networking.

QR module 108 is composed of hardware and software that is capable of generating and displaying a Quick Response code (QR code), or reading a QR code, based on the specific design needs of parking machine 100. The required processes, hardware, and software for QR code generation and display, along with QR code reading, are well-known in the art and will not be discussed further here.

Optional NFC module 106 is composed of hardware and software that is capable of transmitting and receiving near-field communications. The required processes, hardware, and software for near-field communications are well-known in the art and will not be discussed further here.

Server 110 is composed of hardware and software that is capable of communicating electronically with communication module 104, and is capable of communicating electronically with mobile device 120 by utilizing mobile device communication means 130.

Mobile device communication means 130 is composed of hardware and software infrastructure that allows mobile computing devices, such as mobile phones or tablet computers, to send and receive electromagnetic signals of the type that are commonly used in computer networking or cellular telephone communications.

Mobile device 120 is a computing device, such as a mobile phone or tablet computer, that is capable of running an application, scanning a QR code, and communicating electronically with server 110 by utilizing mobile device communication means 130.

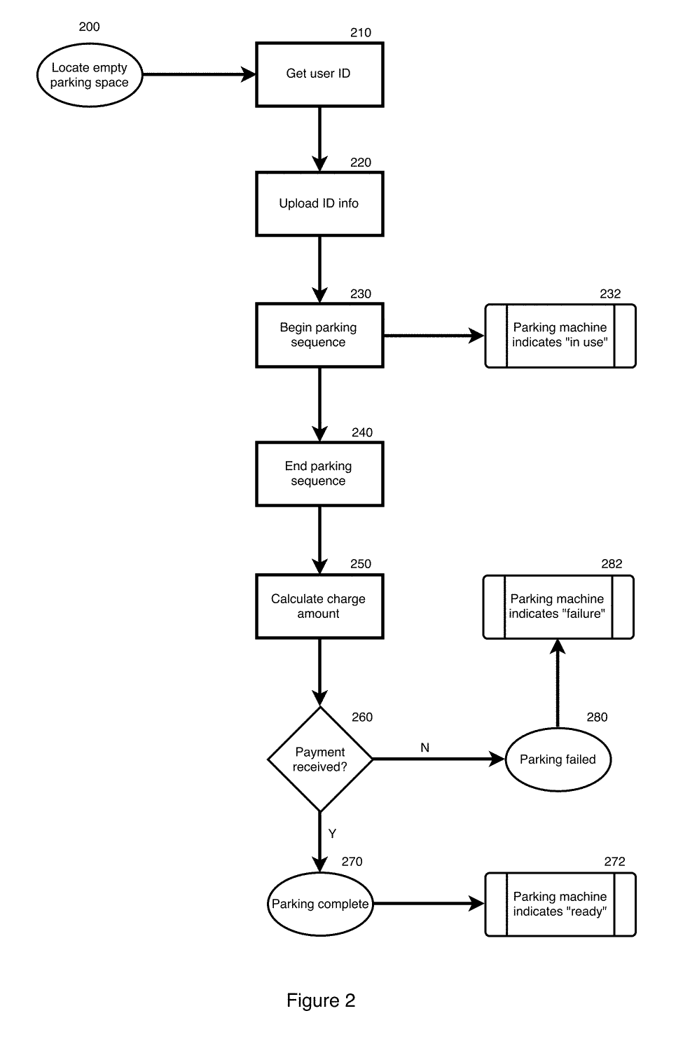

In the particular embodiment illustrated in FIG. 2, the process begins with step 200. In step 200, a user locates an empty parking space, potentially by inspecting the indicator light 102 of a parking machine 100, where a green color indicates that parking machine 100 is ready for use.

At step 210, parking machine 100 acquires the particular user ID assigned to the user. This can be accomplished through various means, such as the QR module 108 of parking machine 100 scanning a QR code generated by the user's mobile device 120, or the NFC module 106 of parking machine 100 communicating with the user's mobile device 120 and receiving the user ID. Alternately, QR module 108 of parking machine 100 can generate a QR code that is scanned by the user's mobile device 120; user's mobile device 120 then communicates the user ID to server 110 via communication means 130; server 110 communicates the user ID to parking machine 100 via communication module 104.

At step 220, parking machine 100 connects to server 110 via communication module 104. Parking machine 100 then uploads the previously acquired user ID and a unique machine ID identifying parking machine 100.

At step 230, server 110 starts a timer. Server 110 also sends a communication to parking machine 100 indicating that parking use has begun. At sub-step 232, parking machine 100 responds to this communication by switching the color of indicator light 102 to red, indicating that parking machine 100 is in use.

At step 240, the user indicates via mobile device 120 that he is ready to leave. The mobile device 120 sends a communication to server 110 via communication means 130 to indicate that parking has completed. Server 110 stops the timer.

At step 250, server 110 calculates a total charge amount based on the time elapsed on the timer. Server 110 attempts to charge the total charge amount to an account associated with the user. If the payment attempt succeeds, server 110 sends a communication to parking machine 100 indicating that parking use has ended successfully. If the payment attempt fails, server 110 sends a communication to parking machine 100 indicating that payment has failed.

At step 270, parking machine 100 receives the communication that parking use has ended successfully. Parking machine 100 then initiates sub-step 272, where the color of indicator light 102 is switched to green.

At step 280, parking machine 100 receives the communication that payment has failed. Parking machine 100 then initiates sub-step 272, where the indicator light 102 is flashed in a yellow color.

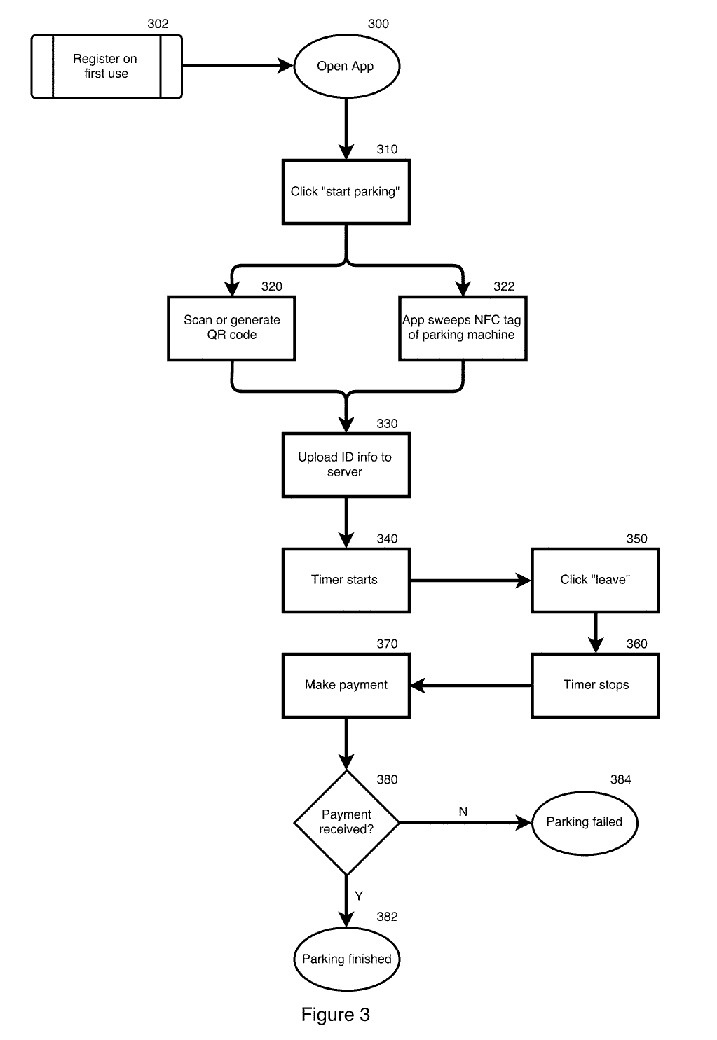

FIG. 3 illustrates the flow of the software application that runs on a user's mobile device 120. When a user runs the application, step 302 occurs and the application checks if a user has previously registered. If a user has not previously registered, the application requires the user to register by inputting payment information. A unique user ID is also assigned to the user upon registration.

After a user registers or the application determines that a user has previously registered, step 300 occurs and the main application opens. This step presents the user with the option to start parking.

When a user indicates he wishes to continue with starting parking in the application, step 320 or step 322 occurs, depending on the configuration of the software and the parking system. At step 320, the application generates a QR code that is read by QR module 108 of parking machine 100, or the application reads a QR code that is generated by QR module 108 of parking machine 100. Alternately, at step 322 the application communicates with NFC module 106 of parking machine 100. The application acquires the machine ID of parking machine 100 at this step.

When either step 320 or step 322 completes, step 330 commences and the application connects to server 110 via communication means 130. The user ID and machine ID are uploaded to server 110.

At step 340, the application starts a timer and displays an option to “leave.”

Step 350 occurs when the user initiates the “leave” option.

At step 360, the timer stops, and the elapsed time is calculated and may be synchronized with the elapsed time that is calculated by server 110. The total charge amount is calculated based on the elapsed time and a parking rate.

At step 370, the application attempts to charge the total charge amount against the payment method specified during registration.

At step 380, the application determines whether the payment succeeded or failed. If the payment succeeded, step 382 commences. If the payment failed, step 384 commences.

At step 382, the application communicates to server 110 via communication means 130 that the payment was successful. The application displays a notification to the user that parking is finished.

At step 384, the application communicates to server 110 via communication means 130 that the payment has failed. The application displays a notification to the user that parking has failed.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

What is claimed is:

1. An electronic parking payment system comprising:
a processor;
a communication unit;
an input unit;
an indicator light;
a client unit;
a server unit;
a computer readable storage media that comprises instructions stored in the computer readable storage media that are executable with the processor, the instructions comprising:
instructions for the input unit to receive parking start input from the client unit;
instructions to transmit parking start information about the client unit and the processor from the communication unit to the server unit in response to the input unit receiving parking start input from the client unit;
instructions for the server unit to begin a timer in response to the server unit receiving parking start information;
instructions to change the color of the indicator light in response to receiving parking start input from the client unit;
instructions for the input unit to receive parking end input from the client unit;
instructions to transmit parking end information about the client unit and the processor from the communication unit to the server unit in response to the input unit receiving parking end input from the client unit;
instructions for the server unit to end a timer in response to the server unit receiving parking end information;
instructions to change the color of the indicator light in response to receiving parking end input from the client unit;
instructions for the server unit to compute a parking charge in response to the server unit receiving parking start information.

2. The electronic parking payment system of claim 1, wherein the input unit comprises a QR code scanner.

3. The electronic parking payment system of claim 1, wherein the input unit comprises a QR code generator.

4. The electronic parking payment system of claim 1, wherein the input unit comprises a near-field communication device.

5. A method of electronic payment for parking comprising:
indicating with an indicator light that a parking machine is ready for use;
in response to receipt from a client device of a start parking command:
starting a timer;
indicating with the indicator light that the parking machine is in use;
in response to receipt from the client device of an end parking command:
stopping the timer;
indicating with the indicator light that the parking machine is ready for use;
computing with a computing device a parking charge based on the elapsed time between the stopping and the starting of the timer.
